(19) United States
(12) Patent Application Publication
(10) Pub. No.: US 2007/0114234 A1
(43) Pub. Date: May 24, 2007

(54) Container and process for storing fuel

(75) Inventors: Michael Bauer, Buxheim (DE); Johannes Koppi, Muenchen (DE); Michael Zenner, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/585,896

(22) Filed: Oct. 25, 2006

(30) Foreign Application Priority Data
Nov. 21, 2005 (DE) 10 2005 055 321.4

(51) Int. Cl. F17C 13/00

(52) U.S. Cl. 220/560.11

(57) ABSTRACT

A container for use as a storage device for a substance for operating a drive assembly of a motor vehicle is provided, in particular for a cryotank for condensed gases. At least one inner container receives the substance for operation. The inner container is held in at least one outer container, where at least parts of the inner container and/or the outer container are made of plastic, and these container parts have at least in part a coating or a metal inlay. The container is characterized by the fact that the outer side of the inner container has a full-surface metal or ceramic coating.

### BACKGROUND AND SUMMARY OF THE INVENTION

This application claims the priority of German Application No. 10 2005 055 321.4, filed Nov. 21, 2005, the disclosure of which is expressly incorporated by reference herein.

The invention relates to a container for use as a storage device for storing a substance for operating a drive assembly of a motor vehicle. In particular, it relates to a cryotank for storing condensed gases.

From DE 101 63 029 A1 it is already a known practice to produce high-pressure hydrogen tanks from a resinous container body on whose inner side a hydrogen barrier layer of synthetic rubber is applied as a coating. The outer side of the container body is reinforced by fiber-reinforced material, which is wound around the jacketing by turning about an aluminum alloy center as a bearing shaft. The center consists of a cover center and an end center.

It is also a known practice to use double-walled, vacuum-insulated containers for storing cryogenic fuels. For this, the pressure container is encircled by an outer container jacket, and the intermediate space between the pressure container and the outer container jacket is essentially evacuated and/or provided with a material for heat insulation. To fix the pressure container in its outer container jacket, tubular and profiled connectors are used, which are guided by way of ducts through the pressure container and receive the pressure container in the outer container jacket in order to produce a double-walled vacuum-insulated container.

It is an object of the present invention to provide a container as a storage device for fuels, in particular cryogenic fuels, for use in motor vehicles, the container being economical to produce, having low weight, and having low fuel permeation.

This, and other, objects are achieved by providing a container for use as a storage device for a substance for operating a drive assembly of a motor vehicle having at least one inner container to receive the substance for operation, which is held in at least one outer container in a manner insulated from heat, where at least parts at least one of the inner container and the outer container are formed of plastic, and these plastic container parts have at least in part at least one of a coating and a metal inlay wherein an outer side of the inner container has a full-surface metal or ceramic coating.

The invention relates to a container for use as a storage device for a substance for the operation of a drive assembly of a motor vehicle. In particular, it relates to a heat-insulated cryotank for condensed gases, which includes at least one inner container to receive the substance for operation, which is held in at least one outer container, where at least parts of the inner container and/or the outer container are made of plastic and these container parts have at least in part a coating or a metal inlay. The container is characterized by the fact that the outer side of the inner container has a full-surface metal or ceramic coating.

This has the advantage that the barrier properties of the container are clearly improved in comparison to the permeation of fuel through the plastic parts. Since large-surface container parts can consist of plastic, the container is very light in comparison to a steel container. Due to the lower outgassing of the surfaces, the vacuum stability is more constant with lower diffusion. The reflection capacity of a metallic layer also causes a lower heat input into the container. Furthermore, chemical resistance and electromagnetic compatibility through grounding are higher.

In an advantageous embodiment of the invention, the full-surface metal or ceramic coating consists of pure metals, in particular aluminum, of metal alloys, in particular copper, nickel, or gold alloys, or of metal oxides, in particular aluminum oxide.

In additional advantageous embodiments of the invention, the container parts consisting of plastic have layers of fibrous composite material applied repeatedly. Along with this, metal parts of the inner container may be connected to the plastic parts of the inner container by gluing, and/or by use of rivets, and/or by use of screws within the full-surface metal or ceramic coating. Advantageously, in this way it is possible in a simple manner for the full-surface metal or ceramic coating to cover the outer side of the inner container as one piece, without interruptions or fastening points, e.g., rivets, screws, etc.

In an advantageous process for producing a container according to the invention, metal, in particular copper or nickel, an alloy based on copper and nickel, or a phosphorous-nickel alloy, is applied by chemical and/or vacuum deposition on the outer side of the inner container. Subsequently, at least one additional layer, in particular of pure aluminum or of an aluminum alloy, can then be deposited electrolytically on the outer side of the inner container.

The production becomes particularly simple by constructing the container from its interior outwards. This also makes possible simple integration of inserts in the inner container. The inserts can simply be injected around the inner container. Additional connections such as connections from the inner container to the outer container, may be realized advantageously and in a simple manner by inserts.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a container according to the invention in a side view;

FIG. 2 shows the container from FIG. 1 in a plan view;

FIG. 3 shows a cross section of the container from FIG. 1; and

FIG. 4 shows a perspective view of the container from FIG. 1.

### DETAILED DESCRIPTION OF THE DRAWINGS

The figures show an inner container in three views and one section. The outer container and the insulation between the inner container and outer container are not represented.

In the figures the same terms and reference numbers are used for identical parts.

In a container according to the invention and for storing cryogenic fuel, e.g., hydrogen, in a motor vehicle, a form of an inner container, e.g., according to the perspective representation in FIG. 4, can be produced. Visible from outside, an inner container plastic jacket part 10 with a full-surface, aluminum alloy coating 11 and constructed so as to be symmetric to the central axis is provided. An outer container jacket is not shown. The inner container is fastened in the outer container with a suspension device 12 fastened to the inner container jacket.

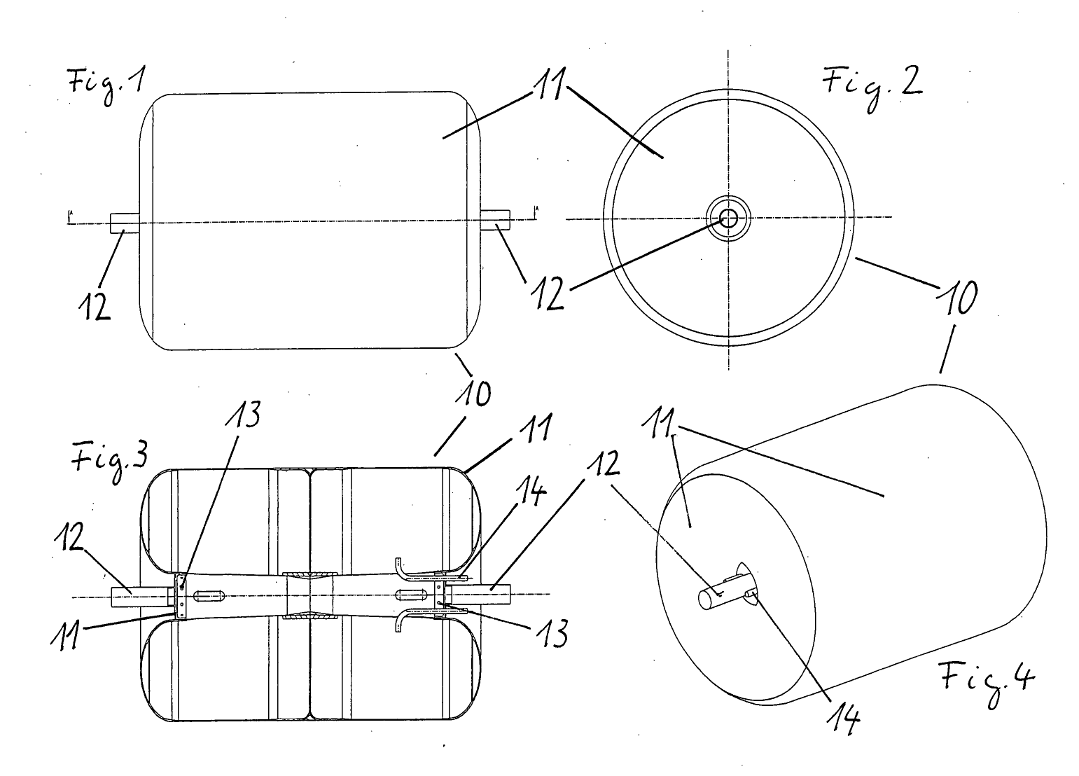

In the representation of FIGS. 1 and 2, the same devices are shown in different views, i.e., an inner container 10 according to the invention and designed as a pressure container of circular cross section. Stored in this container is hydrogen, in liquid and gaseous form, and usable as a substance for operating a drive assembly (not represented) of a motor vehicle (also not represented).

The outer container jacket (not represented), whose form can be produced so as to correspond to that of the inner container jacket, encircles the inner container jacket 10 at an essentially constant distance. The intermediate space between the inner container jacket 10 and the outer container jacket is evacuated and filled with a heat insulation material (not shown), e.g., with hollow microspheres.

A so-called insert of metal is mounted on the inner container jacket by means of rivets 13 (FIG. 3) so as to be centered with respect to the central axis thereof, wherein the insert is also coated on its outer side by the full-surface metal coating 11 on the outer side of the inner container. The insert, as a metal part of the inner container, reinforces the plastic inner container, serves as a bearing and suspension device 12 of the inner container in the outer container, and as a fastening device for ducts to and from the inner container, such as, for example, filling and discharge lines 14.

The inner container is constructed from its interior outwards, e.g., in the following manner: free-form core or hollow plastic core, various layers of carbon fibers and insert, then the full-surface metal coating 11, as a barrier layer against fuel permeation. The metallic layer 11 of an aluminum alloy is applied by chemical deposition in a vacuum on the outer side of the inner container. Subsequently, an additional layer of pure aluminum is deposited electrolytically on the outer side of the inner container.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A container for use as a storage device for a substance for operating a drive assembly of a motor vehicle, comprising:
at least one inner container to receive the substance for operation; and
at least one outer container in which the inner container is held in a manner insulated from heat, where at least parts of at least one of the inner container and the outer container are formed of plastic, and these plastic container parts have at least in part at least one of a coating and a metal inlay;
wherein an outer side of the inner container has a full-surface metal or ceramic coating.

2. The container according to claim 1, wherein the full-surface metal or ceramic coating comprises at least one of pure metals, metal alloys, and metal oxides.

3. The container according to claim 2, wherein the at least one of the pure metals, metal alloys and metal oxides comprise at least one of aluminum, copper, nickel, gold, and aluminum oxide.

4. The container according to claim 1, wherein the container parts formed of plastic have layers of fibrous composite material applied repeatedly.

5. The container according to claim 1, wherein metal parts of the inner container are connected to the plastic parts of the inner container by at least one of gluing, rivets, and screws within the full-surface metal or ceramic coating.

6. The container according to claim 2, wherein metal parts of the inner container are connected to the plastic parts of the inner container by at least one of gluing, rivets, and screws within the full-surface metal or ceramic coating.

7. The container according to claim 4, wherein metal parts of the inner container are connected to the plastic parts of the inner container by at least one of gluing, rivets, and screws within the full-surface metal or ceramic coating.

8. The container according to claim 1, wherein the storage device is a cryotank for condensed gases.

9. A process for producing a container according to claim 1, wherein metal, in particular copper or nickel, an alloy based on copper and nickel, or a phosphorous-nickel alloy, is applied by chemical and/or vacuum deposition on the outer side of the inner container.

10. The process for producing a container according to claim 9, wherein subsequently, at least one additional layer, in particular of pure aluminum or of an aluminum alloy, is deposited electrolytically on the outer side of the inner container.
